(19) United States
(12) Patent Application Publication
(10) Pub. No.: US 2005/0200261 A1
(43) Pub. Date: Sep. 15, 2005

(54) Low work function cathode

(75) Inventors: Dongsheng Mao, Austin, TX (US); Zvi Yaniv, Austin, TX (US); Richard Fink, Austin, TX (US); Igor Pavlovsky, Austin, TX (US)

Correspondence Address: Kelly K. Kordzik;Winstead Sechrest & Minick P.C., P.O. Box 50784, Dallas, TX, 75201, US

(73) Assignee: Nano-Proprietary, Inc., Austin, TX (US)

(21) Appl. No.: 11/123,510

(22) Filed: May 6, 2005

Related U.S. Application Data
(63) Continuation-in-part of application No. 10/715,934, filed on Nov. 18, 2003.
Application No. 10/715,934 is a continuation-in-part of application No. 10/005,989, filed on Dec. 5, 2001, now Pat. No. 6,885,022.
(60) Provisional application No. 60/254,374, filed on Dec. 8, 2000.

(51) Int. Cl. H01J 1/02; H01J 1/05; H01J 1/14

(52) U.S. Cl. 313/311; 313/309; 313/351

(57) ABSTRACT

Field emission properties may also be improved by coating the carbon materials with metal oxides. These metal oxides contribute to lowering the work function of the carbon material as well as improve the life of the field emission properties of the carbon materials, especially under high current density operation.

### CROSS-REFERENCE TO RELATED APPLICATIONS

The present application is a continuation-in-part of U.S. patent application Ser. No. 10/715,934 filed Nov. 18, 2003, which is a continuation-in-part of U.S. patent application Ser. No. 10/005,989 filed Dec. 5, 2001, which claims priority to U.S. Provisional Patent Application Ser. No. 60/254,374 filed Dec. 8, 2000.

### TECHNICAL FIELD

The present invention relates in general to field emission devices, and in particular to field emission devices comprising carbon nanotubes.

### BACKGROUND INFORMATION

Carbon films, including carbon nanotube (CNT) materials, are being developed for cold cathode applications. These applications include field emission displays, x-ray tubes, microwave devices, CRTs, satellite thrusters, or any applications requiring a source of electrons. There are many types of carbon films that are being considered. The emission mechanism believed to be responsible for the emission of electrons from these carbon films is the Fowler-Nordheim theory; this is especially true for the carbon films that are conducting. Included in this emission mechanism is an electrical barrier at the surface of the conductor that prevents electrons from exiting the metal. However, if a strong field is applied, this barrier is lowered or made thin such that electrons can now “tunnel” through the barrier to create a finite emission current. The height of this barrier is partially determined by the work function at the particular surface of the material. The work function is dependent on the material, which surface of the material an attempt to extract electrons is being made, whether or not there are impurities on this surface and how the surface is terminated. What is important is that the lower the work function, the lower the barrier becomes and the easier it is to extract electrons from the carbon film. If a means or treatment is developed that lowers the value of the work function, then it becomes easier to extract electrons from the film; easier in the sense that lower extraction fields are required and higher currents can be obtained from treated films as opposed to untreated films operated at the same extraction field.

In analyzing field emission data, there are four unknowns in the Fowler-Nordheim (F-N) equation. These are n, ∀, ∃, and M with n the number of emission sites (e.g., tips), ∀ the emission area per site, ∃ the field enhancement factor and M the work function. The F-N equation is given by:
I=∀ A exp B
with
A=1.54 10 ⁻⁶ E²/M
B=−6.87 10⁷ M^{1.5} v/E
v=0.95−y2
and
y=3.79 10⁻⁴ E^{0.5}/M

The field at an emission site is E=E0 with E0=V/d where V is the extraction voltage and d the cathode-to-anode distance.

To see the effect that work function has on the field emission current, the graph in FIG. 1 shows how lowering the work function from 4.6 eV to 2.4 eV significantly lowers the threshold electric field and allows much higher current densities (orders of magnitude) at a given electrical field.

Single wall carbon nanotubes (SWNTs) and multiwall carbon nanotubes (MWNTs) can be used as carbon materials for field emission applications because they are tall and thin and have sharp features. These sharp features enhance the electric field at these points (large.), thus a larger field can be achieved with a given applied voltage. Being made of carbon, they are also conductive, mechanically very strong, and chemically robust. The work function of the SWNT material (4.8 eV) is slightly higher than graphite (4.6-4.7 eV), as disclosed in Suzuki et al., APL, vol. 76, p. 4007, Jun. 26, 2000, which is hereby incorporated by reference herein.

What is needed is a means of optimizing the field emission properties of a carbon material by lowering the work function of this material. This would improve the emission characteristics of the carbon nanotube material, both SWNT and MWNT.

Recently, it was observed that light is radiated from individual carbon nanotubes during field emission of electrons from the nanotubes. It was explained that this was a result from Joule-heating of the carbon material, i.e., the electric current passing through the tube as a result of field emission current resulted in resistive heating of the carbon material (S. T. Purcell, P. Vincent, C. Journet, and Vu Thien Binh, Phys. Rev. Lett. 88, 105502 (2002)). The incandescence effect was also observed by other groups (A. G. Rinzler, J. H. Hafner, P. Nikolaev, L. Lou, S. G. Kim, D. Tomanek, P. Nordlander, D. T. Colbert, R. E. Smalley, Science 269, 1550 (1995); J. M. Bonard, J. P. Salvetat, T. Stockli, L. Forro, A. Chatelain, Appl. Phys. A 69, 245 (1999)).

The incandescent, red-glow from the carbon nanotube cathode due to the local heating can be observed directly by the human eye. The measured, local emitting surface temperature of one carbon nanotube can be over 1600° C., as measured by a disappearing-filament optical pyrometer. We believe that the field emission current is as high as 1 μA from an individual, glowing CNT. S. T. Purcell et al., using field emission spectroscopy to quantitatively measure the temperature at the apex of individual multi-walled carbon nanotube (MWNT) during field emission, measured a temperature up to 2000 K. At these high temperatures, residual oxygen or water molecules in the vacuum ambient can react with the carbon atoms and etch away the carbon nanotube, resulting in burn-out and degradation of the field emission properties of the carbon nanotube cathode. The residual oxygen or water vapor is made more reactive by collisions of these molecules with the beams of electrons emitted from the carbon nanotubes. As the emission current increases, the temperature of the nanotube increases and the reactivity of the residual molecules increases, thus significantly decreasing cathode life. For applications requiring high current and extended operation, carbon nanotube cathodes, therefore, should operate in an ultra high vacuum chamber (˜10⁻¹⁰ Torr) to reduce the number of these residual molecules. This may be impractical for most of these applications. The problem is further exacerbated by non-uniform current distribution between the carbon nanotubes; some nanotubes are better emitters than others, thus concentrating the emission current on a few nanotubes.

If the temperature from self-heating of CNTs is not high enough to react with oxygen in vacuum, then long life is possible. This was confirmed by operating MWNT emitters at a relatively low field emission current density in a vacuum test chamber (˜10⁻⁷ Torr), as indicated in FIG. 13. The lifetime of carbon nanotube cathodes was tested out to 85 hours with a degradation of less than 1% with a current density of the cathode of 33 mA/cm², which was not high enough to result in high-temperature self-heating to destructively damage the CNTs. High temperatures were measured by a disappearing filament optical pyrometer. The temperatures of the emitters operated at higher current density, is shown in FIG. 14, which shows an I-V curve of electron emission current density as a function of applied electric field. At these higher current densities, the cathode started to degrade as a result of the issues stated earlier. FIG. 15 shows a digital image of the light from glowing CNTs as taken by a CCD camera at a current density of 66 mA/cm².

The high local temperature of the nanotubes during high current density operation may have other adverse effects. Some materials used to lower the work function of surfaces also have low vapor pressures, i.e. they evaporate at relatively low temperatures. An example is cesium metal (Cs). Although Cesium-intercalated CNTs could lower the work function of CNTs from previous reports (Satoru Syzuki, et al. Appl. Phys. Lett. 76, 4007 (2002); A. Wadhawan, R. E. Stallcup II, and J. M. Perez, Appl. Phys. Lett. 78(1), 108-110(2001)), instability of Cs at high temperatures would limit the practical high-current applications of CNT emitters due to the nature of self-heating. Cesium has a high vapor pressure of 10⁻⁴ Torr at a temperature of only 30° C. At temperatures of 1600° C. -2000° C., Cs will evaporate very quickly; it will not stay around long.

Based on these facts, preventing damage from residue gas bombardment and etching in the operating vacuum environment is critical to securing a long and stable field emission from carbon nanotubes. Finding low work function materials to treat the CNTs such that they withstand high-temperature operation is also needed.

In summary, problems to solve are:
1. to lower the work function of the carbon nanotube emitters such that it is easier to extract the electrons from the nanotubes operated in a field emission mode;
2. to lower the work function in such a way that it is stable during high emission current and thus high local temperature operation; and
3. to provide a coating on the carbon nanotubes that provides a higher degree of protection from ion bombardment of oxygen species and reactive ions and molecules.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a graph of current density versus electric field;

FIG. 2 illustrates a graph of work function versus surface concentration of alkali or metallic atoms;

FIG. 3 illustrates an apparatus configured in accordance with an embodiment of the present invention;

FIG. 4 illustrates a display;

FIG. 5 illustrates a data processing system;

FIG. 6 illustrates a method of making in accordance with an embodiment of the present invention;

FIG. 7 illustrates a ball milling device used to grind carbon nanotubes;

FIG. 8 illustrates how metal ions (e.g., Cs⁺) are adsorbed onto the surface of carbon nanotubes;

FIG. 9 illustrates a spraying technique used to deposit metal salt-treated carbon nanotubes onto a surface;

FIG. 10 illustrates a screen printing device, which can be used in the depositing of a metal salt-treated carbon nanotube dispersion onto a substrate;

FIG. 11 illustrates how dispensing or ink jet printing can be used to deposit a dispersion of metal salt-treated carbon nanotubes on a substrate;

FIG. 12 depicts a graph of the emission current vs. electric field for untreated carbon nanotubes (CNT) and Cs salt-treated carbon nanotubes (Cs-CNT);

FIG. 13 illustrates a lifetime test of CVD grown multi-walled carbon nanotubes operated at modest current density levels;

FIG. 14 illustrates a graph of electron emission current density as a function of applied electric field;

FIG. 15 illustrates a digital image of light from glowing carbon nanotubes as taken by a CCD camera at a current density of 66 mA/cm²;

FIGS. 16A-D illustrate schematic diagrams showing different configurations of coatings of low work function materials on carbon nanotubes or nano-emitters;

FIG. 17 illustrates lifetime test results of an NgO-coated CNT cathode and an un-treated CNT cathode;

FIG. 18 illustrates a graph of an oxide-coated multi-walled CNT cathode and another cathode without the oxide;

FIG. 19 illustrates an SEM image of a carbon nanotube cathode as described with respect to example 2;

FIG. 20 illustrates a graph of I-V curves from an oxide-coated single-walled carbon nanotube cathode and an untreated cathode without oxides; and

FIG. 21 illustrates a field emission lifetime test of an oxide-coated single-walled CNT cathode.

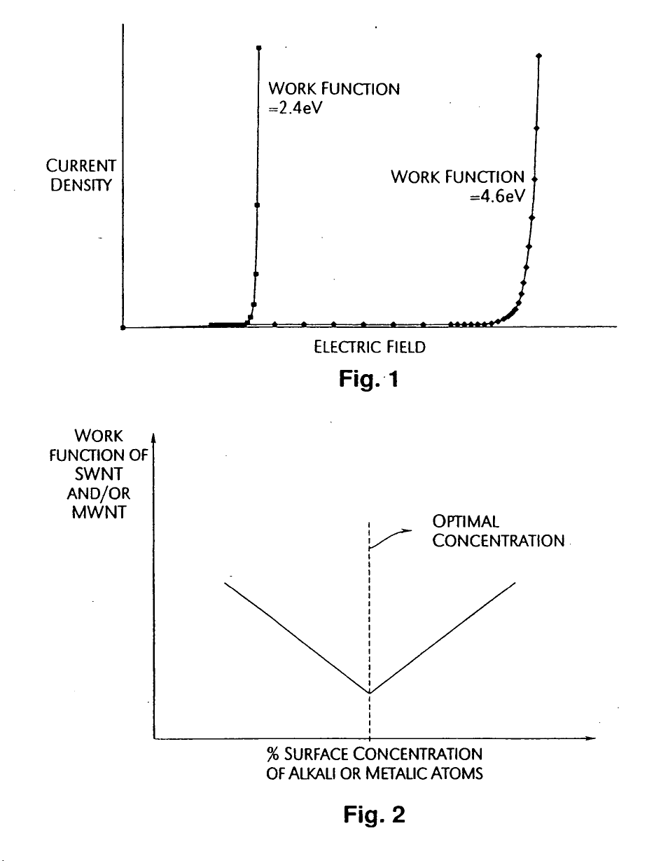

### DETAILED DESCRIPTION

In previous disclosures (cross-referenced above disclosed was a means of optimizing the field emission properties of a carbon material by lowering of the work function by incorporating low work function metals and salts of such metals into carbon nanotubes for use as field emitting materials. In this disclosure field emission properties may also be improved by coating the carbon materials with metal oxides. These metal oxides contribute to lowering the work function of the carbon material as well as improve the life of the field emission properties of the carbon materials, especially under high current density operation.

Carbon nanotubes (CNTs), according to the present invention, include, but are not limited to, single-wall carbon nanotubes (SWNTs), double-wall carbon nanotubes, multi-wall carbon nanotubes (MWNTs), carbon fibrils, buckytubes, metallic carbon nanotubes, semi-conducting carbon nanotubes, semi-metallic carbon nanotubes, chiral carbon nanotubes, chemically-modified carbon nanotubes, capped carbon nanotubes, open-ended carbon nanotubes, endohedrally-modified carbon nanotubes, and combinations thereof. CNTs, according to the present invention, can be made by any known method. Such methods, some of which require metal catalysts, include, but are not limited to, arc-synthesis, chemical vapor deposition, chemical vapor deposition with either a supported or an unsupported catalyst, laser-oven synthesis, flame synthesis, and combinations thereof.

A metal material, according to the present invention, can be comprised of any metallic element or combination of elements of the periodic table which has a work function generally less than about 4 eV, typically less than about 3.5 eV, and more typically less than about 3 eV. Examples of suitable metals include, but are not limited to, alkali metals, alkaline earth metals, transitional metals, rare-earth metals, p-block metals, metal alloys, and combinations thereof. A metal salt, according to the present invention, can be any salt of any of the metal materials described herein. Examples of such salts include, but are not limited to, metal halides, metal nitrates, metal carbonates, metal nitrides, metal oxides, and combinations thereof.

As an example of how metals can affect the work function of a surface, Cs (cesium) atoms lower the work function when they are attached to carbon material, but it has been found that the resistance of a SWNT is a non-monotonous function of the Cs uptake. Resistance decreases initially with Cs uptake, goes through a minimum, then increases with further doping and finally saturates.

Furthermore, Cs can also be used to make a negative electron affinity surface of GaAs. In this case, a monolayer of Cs bonded with oxygen on the surface of GaAs leads to an optimum bending of the conduction and valence band at the surface, making a negative electron surface. Increasing the Cs concentration on the surface leads to a metallic surface with increased work function and highly unstable, very chemically reactive.

When this same principle is applied to SWNTs and MWNTs, the work function of the CNT materials is decreased, and this process may be optimized to obtain an optimal situation in the decrease of the work function material (see FIG. 2).

In some embodiments of the present invention, a CNT layer is grown in situ on a substrate, then metal materials or metal salts are deposited on this layer. In some embodiments, however, the metal materials or salts are deposited during the in situ growth process of the carbon nanotubes. In still other embodiments, metal materials or metal salts are incorporated with the carbon nanotubes after the nanotube growth process, but prior to depositing the nanotubes on a surface.

In some embodiments of the present invention, the CNTs are first grown on a substrate, with subsequent incorporation of metal material and/or metal salts to alter the work function. Some exemplary components of these embodiments are described below.

Substrate Preparation

In some embodiments, the substrate can be considered as a material on which the nanotubes are deposited, and having three constituent parts (layers): substrate base, catalyst, and interface layer in between them.

For many applications, the substrate base is a dielectric material withstanding the temperatures on order of 700° C. (e.g., Corning 1737F glass, B3-94 Forsterite ceramic material). It has been determined that carbon forms on Forsterite substrates over a broader range of deposition conditions than it does on the glass.

In this particular example, a catalyst is consumed during the deposition of the nanotubes (the feature of the CNT formation when carbon grows only on the catalyst interface thus lifting the Ni particle and giving rise to CNTs). The roles of the interface layer are (1) to provide feedlines to the emitter and (2) to be a bonding layer between the glass and the catalyst or nanotubes. Ti—W (10%-90%) successfully fulfills the two functions. In some embodiments, the thickness of the Ti—W coating may be 2000 Å.

The catalyst materials used were Ni and Fe. In typical deposition conditions for Ni, no carbon is formed on the iron catalyst. Ni was likely to have a lower temperature of cracking C—H bonds, though not many experiments have been done with Fe.

The thickness of the Ni catalyst layer is important. If the thickness is too small (<˜70 Å), the crystalline structure of the formed carbon is rather amorphous. So also with a thick Ni coating, 200 Å or more. The advantageous thickness value lies in the range of about 130-170 Å.

Deposition Conditions

Carbon was deposited in a gaseous mixture of ethylene, C₂H₄, and hydrogen, with the use of a catalyst. The flow rates of the gases are of the order of a standard liter per minute, and have comparable values. Typical flow rates for H₂ are 600 to 1000 sccm (standard cubic centimeters per minute), and 700 to 900 sccm for ethylene. The currently used ratio of the gas flows is H₂:C₂H₄=600:800 sccm. The gases used for carbon deposition were H₂, C₂H₄, NH₃, N₂, He. Ethylene is a carbon precursor. The other gases can be used to dilute ethylene to get carbon growth. The temperature was set to 660-690° C. Suitable heating devices include tube furnaces such as a 6-inch Mini Brute quartz tube furnace.

The Deposition Procedure and Timing (Steps 601-602 in FIG. 6)

1. Loading the sample and air evacuation. This step takes about 3 to 5 minutes, until the pressure reaches its base value of about 15-20 mTorr.
2. Back fill. This step replaces a He purge stage used to be a first deposition step in small furnace. The gas used for back filling is H₂. In a large furnace, it takes 10 minutes to get atmospheric pressure within the tube. The temperature in the tube decreases since the hydrogen effectively transfers heat to the distant parts of the tube that have lower temperature.
3. Push to deposition zone.
4. Preheat. It takes about 15 minutes for the substrate to reach equilibrium temperature inside the tube.
5. Deposition. While the hydrogen is on, ethylene is turned on for another 15 minutes to obtain carbon growth.
6. Purge. In fact, purging can be considered a part of the deposition due to slow gas flows along the tube. This step requires the ethylene to be turned off, and lasts 5 minutes with H₂ on.
7. Pull to load zone—Evacuate—Vent—Unload.
   Preparing the Metal Activation

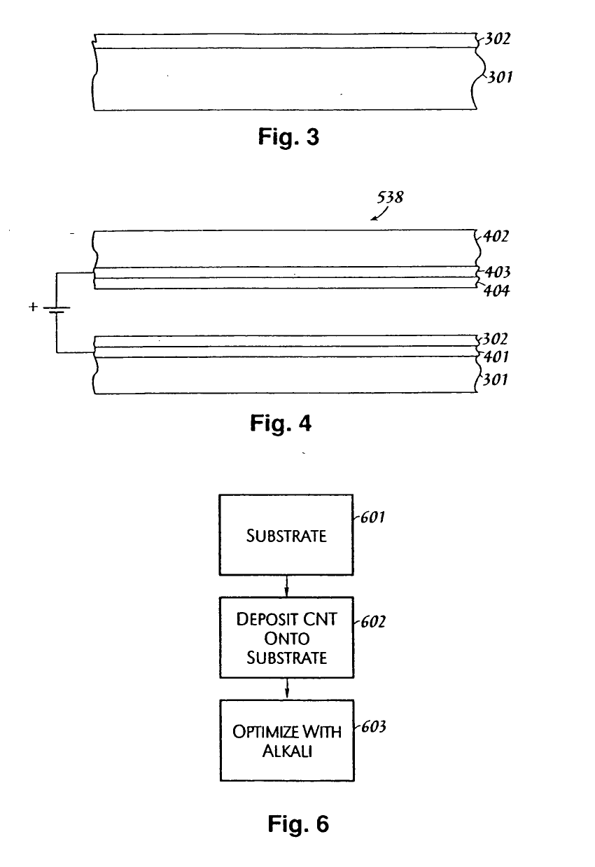

Once the carbon (CNT) film is prepared (steps 601-602 in FIG. 6), the sample can be activated by coating it with a layer of alkali metal (step 603). These metals include lithium (Li), sodium (Na), potassium (K), rubidium (Rb), cesium (Cs), and francium (Fr). Cs lowers the work function more than the other alkali metals. This result is an optimized carbon film with alkali material 302 on a substrate 301 (FIG. 3).

Variations on the Above Embodiments

In some embodiments, the carbon film is placed in a vacuum chamber and a source of Cs is placed with the carbon film such that Cs atoms can be deposited onto the carbon film by evaporation, sputtering, or other physical vapor deposition methods. The thickness of the Cs film is optimized such that the work function of the carbon film is at its lowest.

Another means of coating the carbon film with an metal or alkali metal can be done by depositing a compound of the metal or alkali metal, such as a salt (e.g., CsCl), oxide, nitride or similar compound, onto the carbon film by physical vapor. deposition methods (e.g., evaporation), or by painting, spraying or soaking in a wet solution. This compound can then be optionally decomposed (e.g., reduced to a metal with a reducing agent) in a plasma or by heat to leave only the Cs metal on the carbon film. The amount of Cs can be controlled by metering the amount of the compound placed on the carbon film or by controlling the means of decomposition.

Another means of activating the carbon film is to put the substrate with the carbon film together with a source of alkali metal in a sealed furnace having a vacuum or inert gas atmosphere (e.g. helium, nitrogen, etc.). The sample and source of Cs is heated to high temperatures under high pressures such that the alkali metal atoms intercalate into the carbon film. Intercalation means that the Cs atoms diffuse into the carbon film but do not replace the carbon atoms in the film, and instead fit into positions between layers of the carbon film. The optimization can be controlled by controlling the alkali metal intercalation parameters.

Another means of activating the carbon film is to dope the carbon film with alkali metal atoms. This means that some of the carbon atoms in the CNT matrix are replaced with atoms of alkali metal. This can be done during the growth of the carbon film or after the film is grown.

In some embodiments wherein metal salts are incorporated with CNT material, the step of decomposition or reduction of these metal salts to a metal is unnecessary. In other embodiments, metal incorporated with CNTs is actually converted to a salt material (this can occur spontaneously, for example, when an alkali metal is exposed to air). In some embodiments it is desirous to have metal salts incorporated with the CNTs. In some embodiments, micro- or nano-porous crystals of metal salts incorporated into a CNT material (e.g., adsorbed onto the CNT surface(s)), because of their polar nature, can be oriented in an electric field.

Optimization of Metal Deposition

The optimization of the alkali metal deposition can be performed in at least a couple of different ways.

Several samples can be made and tested for optimal performance. Each sample can have a measured amount of material that is different from the other samples. By correlating the results to the amount of coating or activation, the optimal amount can be defined for the type of sample investigated.

Another method is similar to above, except the emission measuring tools are in the same vacuum chamber as the alkali source. In this way, the sample can be measured for emission at the same time the alkali metal is coating the sample. This has the advantage in that the feedback is in real time and exposure to air does not complicate the results. Once the results are known, then the same amount of material can be applied to other samples without having to monitor the results. The results are expected to be reproducible such that they do not have to be monitored for every sample.

Thereafter, the carbon film with alkali material (302) can be used on a cathode for many applications where emitted electrons are useful, including x-ray equipment and display devices, such as in U.S. Pat. No. 5,548,185, which is hereby incorporated by reference.

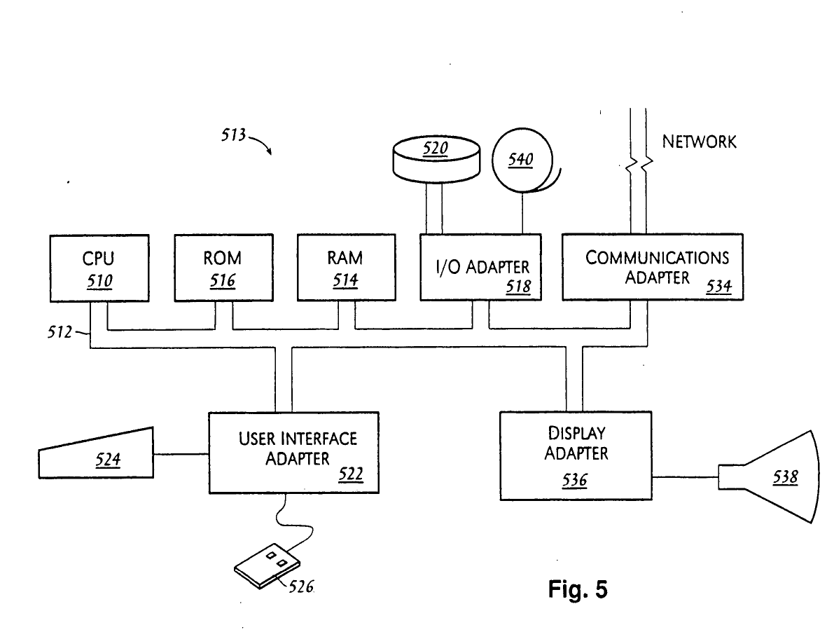

FIG. 4 illustrates a portion of a field emission display 538 made using a cathode, such as created above and illustrated in FIG. 3. Included with the cathode is a conductive layer 401. The anode may be comprised of a glass substrate 402, and indium tin layer 403, and a phosphor layer 404. An electrical field is set up between the anode and the cathode. Such a display 538 could be utilized within a data processing system 513, such as illustrated with respect to FIG. 5.

A representative hardware environment for practicing the present invention is depicted in FIG. 5, which illustrates an exemplary hardware configuration of data processing system 513 in accordance with the subject invention having central processing unit (CPU) 510, such as a conventional microprocessor, and a number of other units interconnected via system bus 512. Data processing system 513 includes random access memory (RAM) 514, read only memory (ROM) 516, and input/output (I/O) adapter 518 for connecting peripheral devices such as disk units 520 and tape drives 540 to bus 512, user interface adapter 522 for connecting keyboard 524, mouse 526, and/or other user interface devices such as a touch screen device (not shown) to bus 512, communication adapter 534 for connecting data processing system 513 to a data processing network, and display adapter 536 for connecting bus 512 to display device 538. CPU 510 may include other circuitry not shown herein, which will include circuitry commonly found within a microprocessor, e.g., execution unit, bus interface unit, arithmetic logic unit, etc. CPU 510 may also reside on a single integrated circuit.

Metal Salt Treatment of Carbon Nanotubes

Further to the present invention, Applicants have found that treatment of carbon nanotubes with metal salt solutions can significantly improve the field emission properties of such materials. Such treatment generally involves immersion of a CNTs in a metal salt solution and subsequent removal of CNTs from the metal salt solution, and optionally washing and/or drying the CNTs.

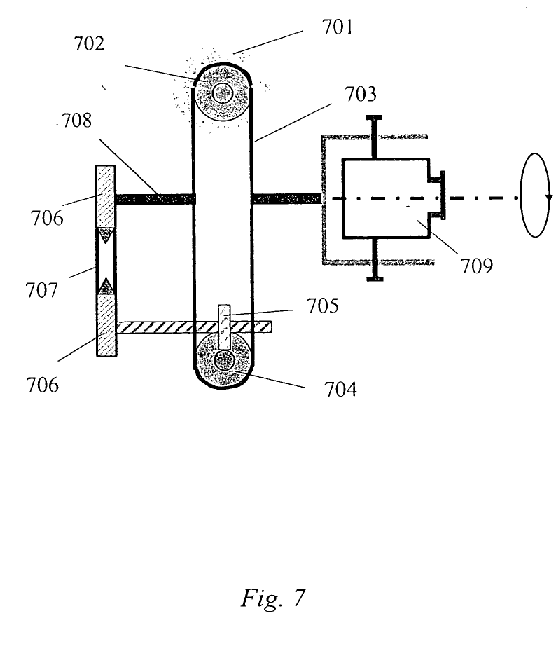

CNTs and metal salts can be any of those described above. CNTs, especially SWNTs, may be ground into powder form prior to immersion in the metal salt solution using, for example, a simple ball mill like that shown in FIG. 7. Such grinding may serve to facilitate dispersion of the CNTs in the metal salt solution and further dispersal aids, such as surfactants, may also be used.

While not intending to be bound by theory, it is believed that the field emission improvement described above is a result of adsorption of metal ions on the surface of the CNTs which in turn can lower the work function of the CNTs, which if left untreated is about 5.5 eV. Alkali metals for which this works include Li (2.93 eV), Na (2.36 eV), K (2.29 eV), Rb (2.261 eV), Cs (1.95 eV) (Handbook of Chemistry and Physics, p12-124, 78^{th} Edition 1997-1998, CRC Press). Besides these alkali elements, some other materials whose work function is generally less than about 4 eV, typically less than about 3.5 eV, and more typically less than about 3 eV, may also be considered effective at improving the field emission properties of the carbon nanotubes. Examples of such metals include, but are not limited to, Ba (2.52 eV), Ca (2.87 eV), Ce (2.9 eV), Gd (2.9 eV), Sm (2.7 ev), Sr (2.58 eV).

This process has several advantages in that 1) large quantities of CNTs can be easily and efficiently surface-treated with metal ions in this manner at relatively low cost; 2) metal ions do not have to be decomposed (e.g., reduced) to their corresponding pure metal; and uniform deposition over large area substrates is possible using currently available low-cost equipment. Such deposition methods include, but are not limited to, spraying a dispersion of such treated CNTs onto a substrate surface.

Variations on the abovementioned embodiments include an optional reduction of the metal salt to a metal. While not intending to be bound by theory, when metal salt treated CNTs are used as the cathode material in field emission devices (see FIG. 4), it is possible that some or all of the metal cations adsorbed onto the CNT surface become reduced when a potential is applied between the cathode and the anode and an emission current begins to flow between them. Further, in some embodiments, micro- or nano-crystals of such metal salts which coat CNTs used in such emission devices, may become oriented when an electric field is generated as such.

The following example is provided to more fully illustrate some of the embodiments of the present invention. The example illustrates methods by which metal salt-treated CNTs can be made and prepared for field emission applications. It should be appreciated by those of skill in the art that the techniques disclosed in the examples which follow represent techniques discovered by the inventor to function well in the practice of the invention, and thus can be considered to constitute exemplary modes for its practice. However, those of skill in the art should, in light of the present disclosure, appreciate that many changes can be made in the specific embodiments which are disclosed and still obtain a like or similar result without departing from the spirit and scope of the invention.

### EXAMPLE

This Example describes a method used to make Cs salt treated-CNTs and their preparation for field emission applications.

1. Treating Carbon Nanotubes with Cs Salts

This process provides a way of contacting Cs ions to the surface of carbon nanotube powders using an Alkali salt/water solution.

A) Source of Carbon Nanotube and Cs Salt

Purified single wall carbon nanotubes (SWNTs) were purchased from Carbon Nanotechnologies, Inc., Houston, Tex., USA. These SWNTs were about 1-2 nm in diameter and about 5-20 μm in length. It is believed that other kinds of carbon nanotubes such as single wall, double-wall or multiwall carbon nanotubes (MWNTs) with different diameters and lengths from other venders could be substituted in this example with similar results.

Cesium nitrate (CsNO₃) was obtained from Spectrum Laboratory Products, Inc. Gardena, Calif., USA. Applicants suggest that other kinds of Cs salt such as CsC₁, Cs₂CO₃, and Cs₂SO₄ could be substituted for CsNO₃ in this example with similar results.

B) Grinding the SWNTs

CNTs can easily agglomerate and form clusters and bundles-held together by van der Waals attractive forces. Thus, it is often beneficial to disperse them before they are immersed in the Cs salt/water solution. A simple ball mill was used to grind SWNT bundles. FIG. 7 is a diagram of this ball mill comprising a motor 701 to which a wheel 702 is attached to a belt 703 which drives a second wheel 704. This second wheel 704, via a turbine 705, gear 706, and chain 707 assembly, drives a shaft 708 which spins a milling chamber 709. It is in this milling chamber 709 that the CNTs and/or particles are placed. The rate at which this machine is typically run is about 50-60 revolutions per minute.

In this particular example, approximately 0.5 g of SWNTs, together with tens of Al₂O₃ balls used for grinding (˜5⁻¹⁰ mm in diameter), were mixed with about 100 ml water. The CNT powders were ground for between 1-14 days in order to fully disperse the carbon nanotubes. Optionally, a surfactant such as sodium dodecylbenzene sulfonate (M. F. Islam, E. Rojas, D. M. Bergey, A. T. Johnson, and A. G. Yodh, Nano Lett.3(2), 269-273(2003), incorporated herein by reference), or similar materials, can also be added to the mixture in order to achieve better dispersion of the carbon nanotubes.

C) Preparation of the Cs Salt Solution

In this example, approximately 2 g of CsNO₃ powder was put into a beaker with approximately 400 ml of water and was stirred using a glass stirbar until the powder was dissolved. The solution can be optionally filtered one or more times to extract impurities and/or difficult to dissolve particles.

D) Immersing the Ground CNT Dispersion into the Cs Salt Solution

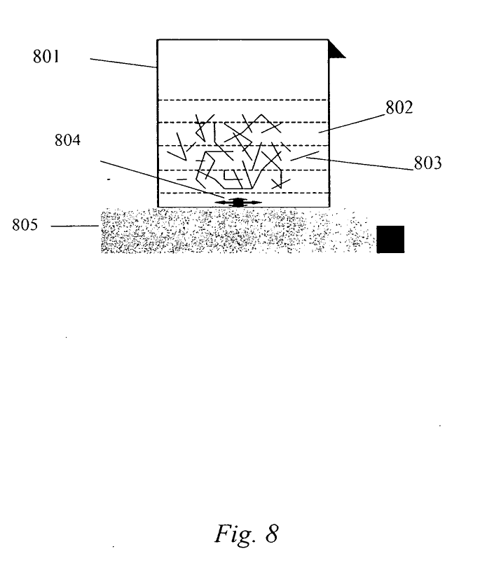

The ground Carbon nanotubes, dispersed in approximately 100 ml of water, was added to the CsNO₃ solution to form a mixture. The total solution volume was 500 ml and the concentration of CsNO₃ was 0.02 M (other concentrations may be more optimal for achieving the best field emission properties from CNTs). Then, the solution was placed onto a hot plate/magnetic stirrer and stirred using a magnetic stir bar for approximately 15-20 hours (the time can be varied in other embodiments such that a the CNTs surface becomes saturated with metal ions. FIG. 8 illustrates how Cs ions are allowed to adsorb onto the surface of CNTs. Referring to FIG. 8, beaker 801 contains CsNO₃/water solution 802, CNTs 803, and a magnetic stir bar 804. The mixture is heated/stirred by a stirring hot plate 805.

E) Washing the CNTs

After the mixture was stirred for approximately 15-20 hours, the CNTs were washed several times using deionized water in order to remove the salt residue in the solution. The water was removed until all the CNTs sank down to the bottom of the beaker. Then, new water was added. After the CNTs were washed, they could be dried in a oven at approximately 40-100° C. for a certain time. In this experiment, the CNT solution was further washed several times with isopropyl alcohol (IPA) in order to then prepare a CNT cathode.

2. Applying Cs Salt-Treated Carbon Nanotubes to the Surface of a Substrate

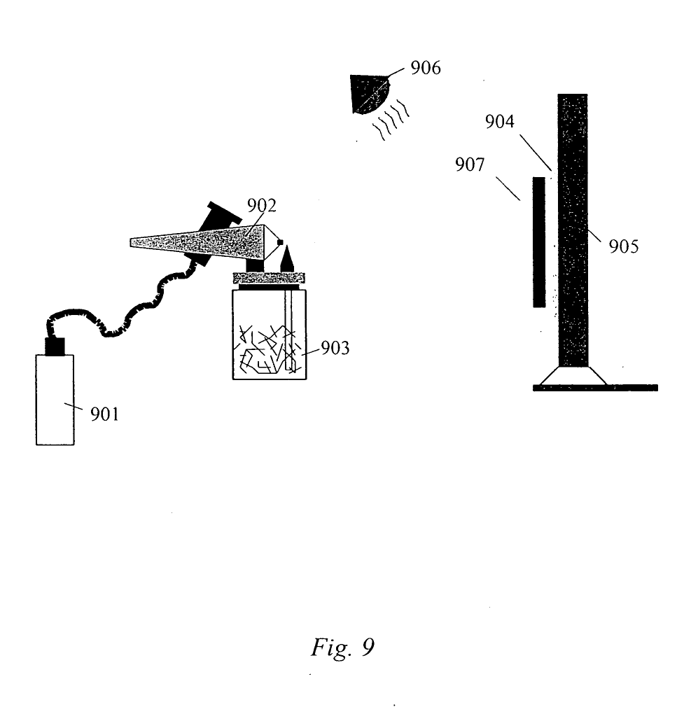

In this Example, a spraying technique was employed to deposit Cs salt-treated CNTs onto a substrate. Because CNTs can easily clump together if they are, an ultrasonic horn or bath was used to redisperse them in an IPA solution just prior to spraying them onto the substrate. In this Example, the CNT-IPA solution was sprayed onto a conventional silicon (Si) substrate comprising an area of approximately 2×2 cm² (such a solution could also be sprayed onto various other substrates such as metal, ceramic, glass, semiconductors and plastics). In order to get better coating uniformity and dispersal on the substrates, more IPA can be added into the above solution prior to spraying. In this Example, the solution used for spraying was a mixture of approximately 0.2 g of Cs salt-treated CNTs in approximately 100 ml of IPA. In alternative embodiments, this solution can be applied to a selective area or areas using a shadow mask. In order to prevent the IPA from flowing to unexpected area, the substrate was heated to approximately 70° C. on both the front side and back side during the spraying process, in order to evaporate the IPA quickly. The substrate was sprayed back and forth and/or up and down several to tens of times until the entire surface was coated with the mixture. The thickness of the mixture was about 1-10 μm. The surface was then dried in air. FIG. 9 illustrates the spraying technique employed in this Example, wherein a condensed gas 901 is used to charge an atomizer 902 containing a solvent-suspended mixture of metal salt-treated carbon nanotubes 903. Mixture 903 is sprayed onto a substrate 904, optionally in contact with heater 905 and/or infrared (IR) heat lamp 906, to form cathode material layer 907 comprising metal salt-treated CNTs.

Techniques other than spraying may also be used to apply the mixture to a surface. Such techniques include, but are not limited to, electrophoretic deposition, dipping, screen-printing, ink-jet printing, dispensing, brushing, and combinations thereof. Other solvents, such as acetone or methanol, may also be used as the carrier (in lieu of IPA) when applying the Cs salt-treated CNTs to a surface.

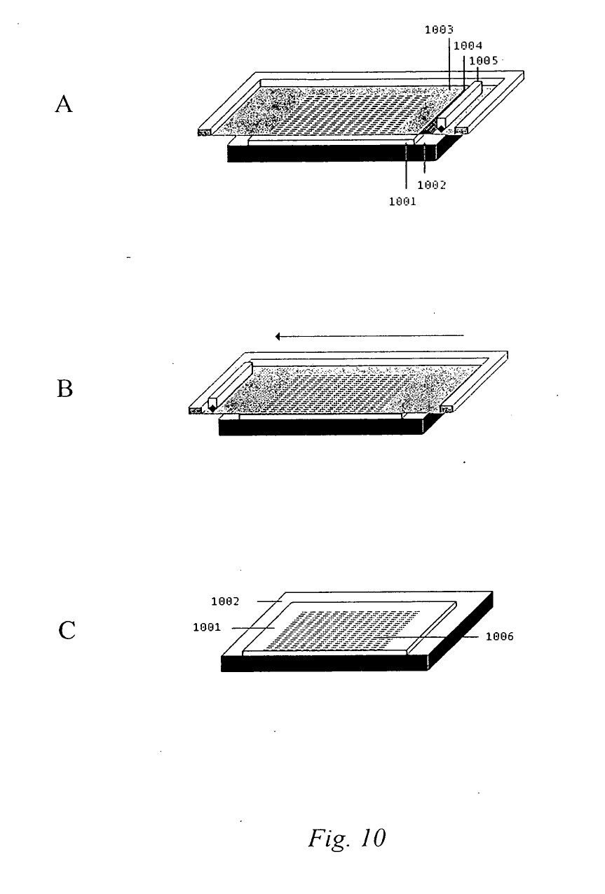

FIGS. 10A-C illustrate a screen printing method by which a dispersion of metal salt-treated carbon nanotubes can be deposited onto a substrate according to some embodiments of the present invention. Referring to FIG. 10A, a substrate 1001 is placed on a substrate stage/chuck 1002 and brought in contact with an image screen stencil 1003. A dispersion 1004 comprising metal salt-treated carbon nanotubes (dispersion 1004 may also comprise insulating or conducting particles such as alumina, silica, or silver, and also standard paste vehicles and thinners to control the viscosity and curing properties of the paste) is then “wiped” across the image screen stencil 1003 with a squeegee 1005, as shown in FIG. 10B. The dispersion 1004 then contacts the substrate 1001 only in the regions directly beneath the openings in the image screen stencil 1003. The substrate stage/chuck 1002 is then lowered to reveal the patterned cathode material 1006 on substrate 1001, as shown in FIG. 10C. The patterned substrate is then removed from the substrate stage/chuck.

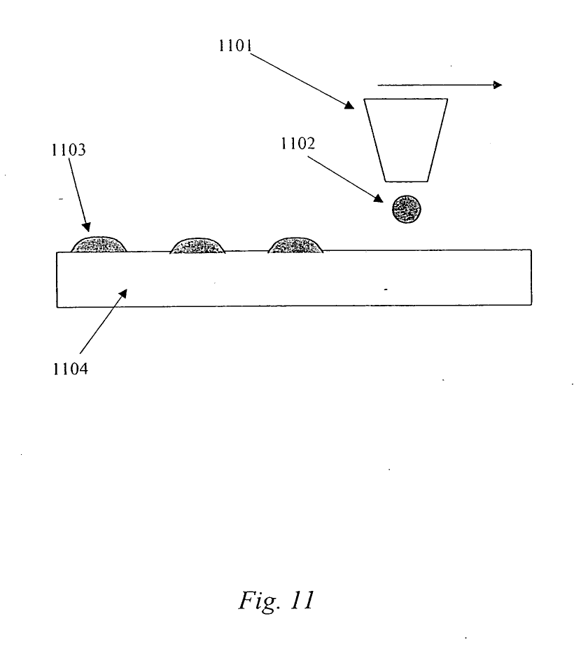

FIG. 11 illustrates an embodiment wherein a dispensor or an ink jet printer is used to deposit metal salt-treated carbon nanotubes onto a substrate. Referring to FIG. 11, printing head 1101 is translated over a substrate 1104 in a desired manner. As it is translated over the substrate 1104, the printing head 1101 sprays droplets 1102 comprising metal salt-treated carbon nanotubes dispersed in a solvent. As these droplets 1102 contact substrate 1104, they form printed cathode material 1103 comprising metal salt-treated carbon nanotubes. In some embodiments, the substrate 1104 is heated so as to effect rapid evaporation of solvent within said droplets. Heat and/or ultrasonic energy may be applied to the printing head 1101 during dispensing.

3. Activation of the CNTs

Once the Cs salt-treated CNTs were deposited onto the surface of the substrate, an activating technique, referred to herein as “tape activation,” can be applied to the CNT film by applying an adhesive tape material to the film and then pealing the adhesive tape away (Yang Chang, Jyh-Rong Sheu, Cheng-Chung Lee, Industrial Technology Research Institute, Hsinchu, T W, “Method of Improving Field Emission Efficiency for Fabrication Carbon Nanotube Field Emitters”, U.S. Pat. No. 6,436,221 B1, incorporated herein by reference).

After the carbon nanotubes were sprayed on to the substrate, an adhesive tape process may be needed to remove the top layer of material from the surface. In this Example, clear tape (3M, Catalog number #336) was optionally used to remove the top layer of material. The tape was applied to the Cs salt-treated CNT layer using a laminating process. Care was taken to ensure that there was no air between the tape and the CNT layer (if a bubble is exists, the mixture at that area will not be removed or treated as the other areas are). A rubber roll was used to further press the tape in order to further eliminate air at the intersection of the tape and the Cs salt treated CNT layer. Finally, the tape is removed.

4. Field Emission Test of the Cs Salt-Treated CNTs in a Field Emission Device

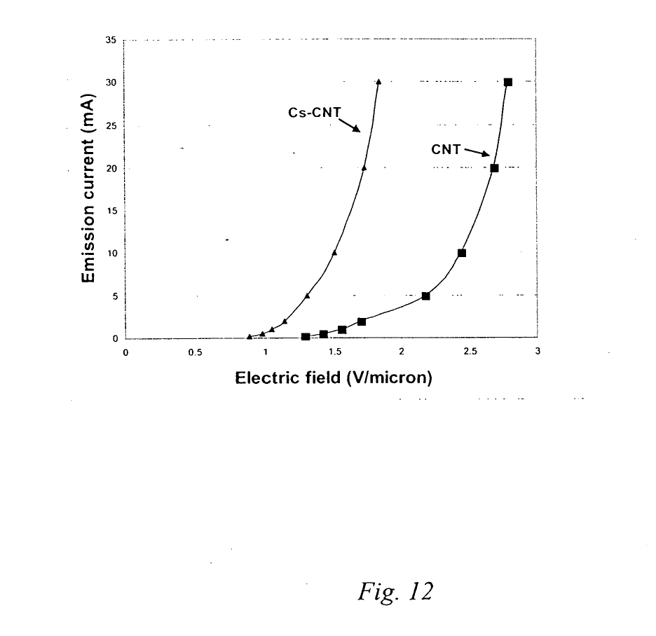

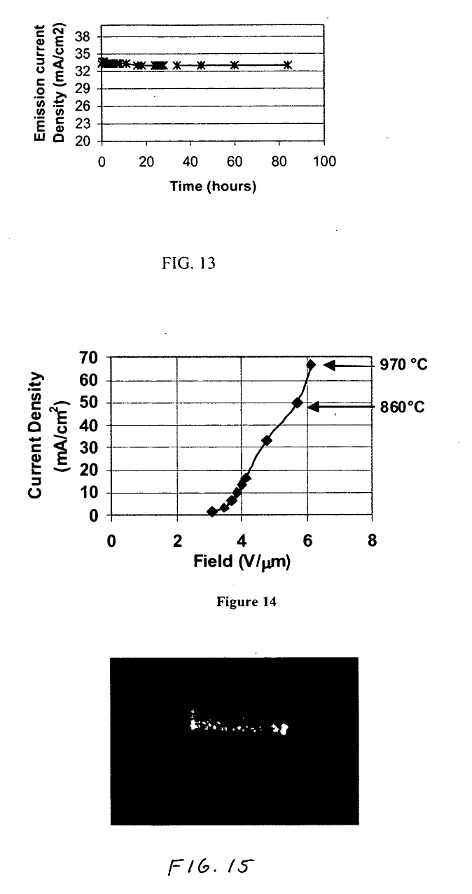

To compare field emission properties, untreated CNTs were also made using the same spray and activation conditions as the Cs salt treated sample. Both samples were then tested by mounting them with a phosphor screen in a diode configuration, like that shown in FIG. 4, with a gap of about 0.63 mm between the anode and the cathode. The test assembly was placed in a vacuum chamber and pumped to about 10⁻⁷ Torr. The electrical properties of the cathode were then measured by applying a negative, pulsed voltage (AC) to the cathode and holding the anode at ground potential and measuring the current at the anode (a DC potential could also be used for the testing, but this may damage the phosphor screen). A graph of the emission current vs. electric field for the two samples is shown in FIG. 12.

It can be seen from FIG. 12 that the Cs salt-treated CNTs have significantly better field emission properties than untreated CNTs. A threshold field of less than 0.9 V/μm and emission current of 30 mA at 1.84 V/μm was achieved for the Cs salt-treated CNTs, whereas the untreated CNTs exhibited a threshold field of about 1.3 V/μm and required a field of approximately 2.80 V/μm to generate an emission current of 30 mA.

Low work function coatings have been used for thermal cathodes for some time. One example is the Schottky emitter. The Schottky emitter combines the high current density and low energy spread of the cold field emitter with the high stability and low beam noise of thermal emitters. The thermal energy, in fact, assists in electron emission since the electrons do not tunnel through the barrier. For such “thermal field emission,” surface treatments with ZrO₂ improve the emission characteristics, particularly the stability of the source.

Such “Schottky” emitters are becoming popular in scanning electron microscopy. One example is the recent work on enhanced low-temperature thermionic field emission from surface-treated diamond cathode (F. A. M. Kock, J. M. Garguilo, Billyde Brown, R. J. Nemanich, Diamond and Related Materials 11, 774 (2002)). An eightfold increase in field emission current (IFE) was observed when temperatures were elevated from 750° C. to 950° C. Enhanced field emission was also obtained from carbon nanotubes when the cathode was heated up to 700° C. (Yi-Chun Chen, Hsiu-Fung Cheng, Yun-Shuo Hsieh, and You-Ming Tsau, J. Appl. Phys. 94, 7739 (2003)).

For MWNTs, the local temperature of CNTs resulting from self-heating is dependent on the emission current and resistance of individual CNTs. For MWNTs, the simulation and experiments demonstrated that the temperature from self-heating ranges from 300 to 2000 K. The resistance of metals increases roughly linearly with temperature. Moreover, the sharpening process of metal tips caused by surface diffusion in turn increases the local field. This creates a positive heating feedback and results in an extremely unstable situation and, hence, metal tips generally breakdown at high temperature without warning. In contrast, the resistance of MWNTs was shown to decrease (T. W. Ebbesen, Nature (London) 382, 54 (1996)) substantially with temperature, giving a negative feedback to heating. Unlike metal tips, surface diffusion is much slower for covalent carbon, which inhibits the field driven sharpening. Even though CNT cathodes have limited lifetimes as well, they are much more graceful and predictable, allowing system designers and operators the opportunity to have service schedules. Even if maintenance is not possible such as in a satellite, scheduled failure is much more acceptable than unpredictable failure.

To achieve higher current at lower fields, a low work function material is needed to coat the carbon emitters to lower the work function from about 5.0 eV. This work function coating must also be able to withstand the high temperatures induced during high emission current densities. From the Fowler-Nordheim emission tunneling theory, lowering the work function of the emission surface increases the emitted current from the field emitter at a given applied field. Thus, to further increase current density and obtain more stable electron sources, low work function materials can be coated onto the carbon emitters or other nano-emitters. The carbon emitters can be multiwall carbon nanotubes, singlewall carbon nanotubes, double wall carbon nanotubes, carbon fibers, carbon flakes or other carbon based emitters. The low work function materials should be carefully chosen to act also as a protection layer to avoid oxygen attack or reactive ion feedback attack in the vacuum environment, which is the main reason for the short life of CNT cathodes. To address these problems, an embodiment of the present invention uses some metal oxide materials as a coating to lower the work function of the carbon emitters. Specifically, disclosed is the use of alkaline earth metal oxides such as BaO, SrO and CaO, although other metal oxides may also work, such as S_{C2}O₃. Compounds of these oxides may also work as well as mixtures of these materials. The coating of the oxide materials may be uniform and completely coated over the surface of the nanotube or nano-emitter, or it may be non-uniformly coated (thicker in some places and thinner in others), or it may be only partially coated (coated in some areas and not coated in other areas).

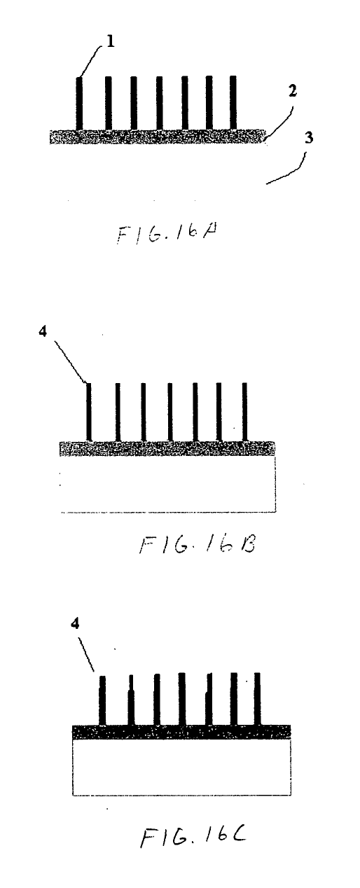

Wet-chemical deposition, electrochemical deposition, and vacuum deposition (including sputtering, evaporation, laser ablation deposition, etc.) can be employed to coat low work function materials on the CNTs. FIGS. 16A-D illustrate different configurations of the coating of low work function material on carbon nanotubes or nano-emitters.

FIG. 16A illustrates a first configuration where a conductive electrode 2, such as a thin metal film or thick metal film, is deposited by screen printing and curing of a metal paste onto a substrate 3. Nanowire or nanotube field emitters 1 are then deposited on the conductive electrode 2. FIG. 16B illustrates a low work function and protection layer for coating the field emitters 1. FIG. 16C illustrates a partial coating on vertically aligned field emitters 1. FIG. 16D illustrates partial coating of a low work function material 6 on randomly aligned field emitters 5. The low work function and protection coatings can be deposited on the nano-sized field emitters using vacuum deposition or electrochemical deposition.

### Example 1

One example of a low work function metal oxide coating on carbon nanotubes is described as follows:

1. A thin metal film (10 nm-1000 nm) is deposited onto glass substrates. TiW films are preferred. Other substrate materials can be chosen such as alumina or bare Si wafers. Conducting substrates may also be used. Many other metal films may also work, such as pure Ti or pure W. In some cases, the TiW film may not be needed. The metal film acts as a electrical contact layer. If the substrate is conducting, then the contact layer may not be needed.

2. Two thin layers of metal are grown on top of the TiW layer to act as a catalyst layer for the CNT carbon growth (next step). First, Cu/Ni (3˜8 nm/3-8 nm) is deposited, then Ni (3-8 nm) is deposited on the substrates. The catalyst layers are deposited using an e-beam evaporator. Other methods may also be used.

3. Carbon nanotubes are grown on the substrates. The substrates with catalytic layer are then mounted into a reactor for depositing the carbon nanotubes. The reactor used may be a quartz tube furnace that operates at high temperatures and with a controlled atmosphere inside the tube. The process is a thermal chemical vapor deposition (CVD) process. The substrate is placed at the cold end of the reactor. After the sample is placed in the reactor, the reactor is closed off to room atmosphere and pumped down to ˜10⁻² Torr using standard rough pumps. The reactor is then back-filled with nitrogen gas to a pressure of ˜50-200 Torr. Nitrogen continues to flow at about 50-200 sccm, but the pressure is regulated with a throttle valve above the pump. Then, the sample is pushed into the center of the furnace where it will heat up to a high temperature. After the sample is pushed into the furnace, the nitrogen gas is switched OFF and hydrogen gas is switched ON, also at a 100 sccm flow rate. The temperature can be in a range from 450° C. to 750° C. A preferred temperature is 600° C., but is highly dependent on other parameters. The samples sit in this environment of flowing hydrogen for about 10-30 minutes to allow the temperature of the substrate to come to an equilibrium with its new environment. Then the hydrogen is switched OFF and acetylene (C₂H₂) gas flow is turned ON at a flow rate of 20-50 sccm. The pressure remains at 50-200 Torr. The time of this period is 5-60 minutes. After this carbon growth period, the acetylene gas flow is turned OFF and the nitrogen gas flow is turned ON at a flow rate of 50-200 sccm. At the same time, the sample is pulled from the hot zone of the reactor to the cold zone and allowed to cool down to near room temperature. After about 10 minutes, the reactor is again evacuated and then vented to air. When the pressure reaches 1 atmosphere, the reactor is opened and the sample is removed, inspected and tested. Flow rates, temperatures and process times may be different for different reactors, depending on the size of the reactor and other parameters. Similar processes known in the art could also be used.

4. After the CNTs are grown on the substrates, about 5 nm MgO layer was deposited on the CVD-grown CNT cathodes by an e-beam evaporator. Because the MgO was deposited by evaporation, the coating is not complete over the CNTs and may not be uniform.

The field emission lifetimes of the MgO-coated CNT cathode and a bare CVD grown CNT cathode were tested using a standard diode configuration. The active surface of the CNT cathode was placed facing a phosphor-coated anode screen. The CNT layer faced the phosphor layer directly. The two plates were spaced apart by about 1 mm by spacers placed between the cathode and anode. The assembly was placed inside a vacuum chamber and evacuated to below 10⁻⁶ Torr. The vacuum chamber had electrical feedthroughs that connected the cathode and anode electrodes to power and ground electrodes external to the chamber. The anode was held near ground potential. The cathode was pulsed negative with a frequency of 1000 Hz and a duty factor of 2%. The cathode negative bias was increased until a designated field emission current from the cathode was achieved.

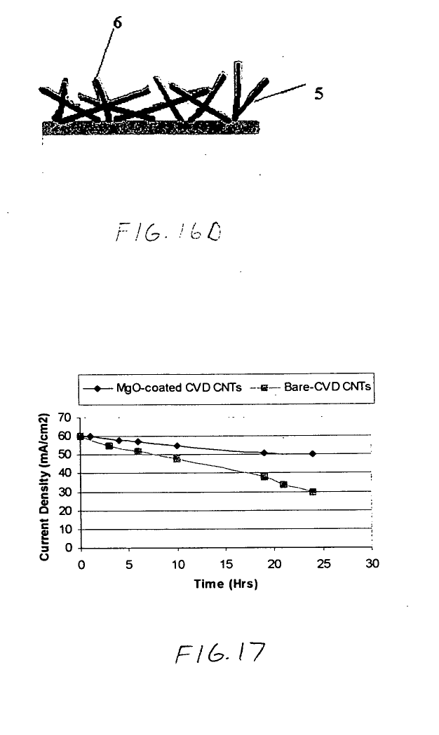

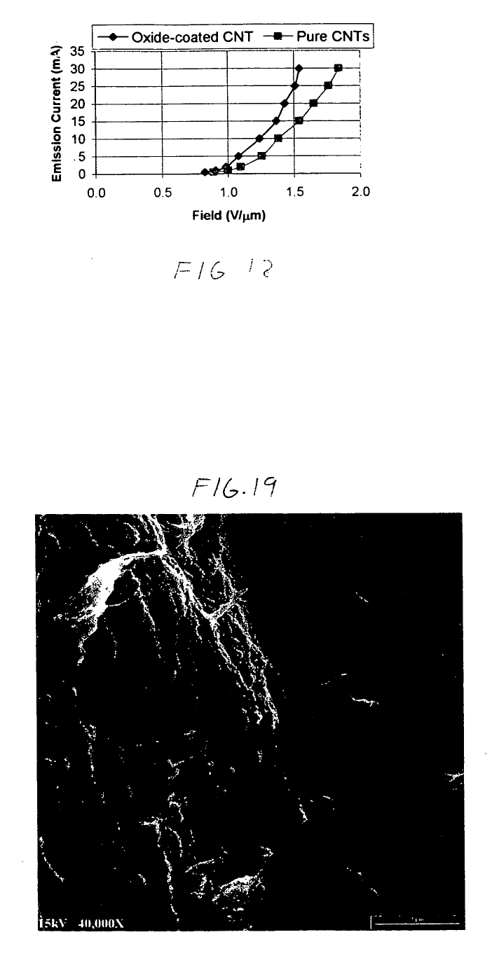

Longer life was observed for the MgO-coated CNT cathode compared to the un-treated CNT cathode, as indicated in FIG. 17. Incandescent light from the nanotubes was observed during the life test with a starting emission current density of 60 mA/cm².

### Example 2

Results showed that by wet-chemically coating an oxide mixture (Na₂O, MgO, Li₂O, and SiOx) layer on carbon nanotubes, the field of CNT emitter for 30 mA-emission current is decreased, as indicated in FIG. 18.

One way to produce a low work function metal oxide coating on carbon nanotubes is described as follows:
1) 95-99 wt. % of water and 1-5 wt % Laponite® clay (available from Southern Clay Products, Inc) are weighted and put into a beaker. Water is added to the Laponite, but the reverse may also work.
2) A stirrer is used to mix in the beaker with a revolution of 50-200 rpm to form a gel. The stir time is 10 to 40 minutes. The Laponite is a synthetic silicate, including Na⁺, Li⁺, Mg²⁺, and SiO₄²⁻.
3) The 90-99 wt. % gel and 1-4 wt. % multi-walled CNTs (several sources are available), and 5-10 wt. % terpineol thinner are mixed to formulate a CNT ink in a beaker.
4) A three-roll mill is used to mix the mixture for one hour to further prepare the gel ink.
5) 200 mesh screen and a screen-printer is employed to deposit the ink on a substrate using standard screen printing techniques known to those skilled in the art.
6) After printing, the substrate is baked in an oven (air atmosphere) for 30 minutes at 230° C. After baking, the gel materials transform into oxides and remain on or mixed with the carbon nanotubes. The thickness of the oxide layer can be controlled by the concentration of oxide gel solution.
7) Activation may be required for the CNT cathode by applying transparent Scotch Brand Tape. The transparent tape is employed to stick to the surface of the CNT cathode using a lamination machine. The substrate passes through the laminator one time to make sure the tape is in firm contact to the surface of CNT cathodes. Then, the tape is pulled away from the surface of the CNT cathode. Some CNT and oxide material may be removed from the cathode surface as a result of removing the tape.

Results indicate that this mixture improves the field emission properties of the CNT-based cathode, as indicated in FIG. 18. The same activation process was applied to each cathode. The field emission properties of the cathode were tested in a pulsed mode with a 2% duty factor as described earlier in Example 1. The oxide coated cathode prepared as described above had a lower threshold field compared to the un-treated CNT.

Life test results were performed similar to the sample shown in FIG. 17. No degradation was observed over 360 hours test when operating at a current density of 80 mA/cm² and field emission field strength of 2.4 V/μm. FIG. 18 is an SEM image of the CNT cathode prepared as described above.

### Example 3

Another method was used to lower the work function of the carbon nanotube emitters as well as extend the life of the emitters in field emission applications. Conventional low work function materials, such as BaO, SrO, CaO, ZrO, etc., or their compounds or mixtures, can be deposited on a CNT cathode by wet chemical deposition. These oxides can also be a protection layer for the CNTs and decrease the risk of etching by oxygen species in vacuum for prolonging lifetime of CNT emitters as well as decreasing their field emission threshold.

The process is described as follows:
1) BaO (20-50 wt. %), SrO (20-50 wt. %), and CaO (10-20 wt. %) are dissolved in water.
2) Carbon nanotubes (1-15 wt. %) from Iljin Corporation are added to the BaO:SrO:CaO water solution. The solution is stirred and heated to 40˜90° C. An intensive reaction can be observed in the mixture solution at the beginning. This may be a result of the metal oxides reacting with water to form hydroxides.
3) The solution is stirred for 12 hours to make sure the reactions were complete between the water and BaO:SrO:CaO. Some of hydroxides and oxides will attach to CNTs during the intensive reaction.
4) After 12 hours, the stir process was halted and the carbon nanotubes were allowed to sink onto the bottom of the beaker. The water is carefully decanted to leave the treated CNTs in the beaker. Water was added to the beaker again and allowed to sit until the CNTs sank onto the bottom of the beaker. The water was again decanted to leave the treated CNTs in the beaker. After 5-10 times repeating this cleaning process, the mixture was dried by evaporating water at 100° C. in an oven.
5) After the CNTs were dry, some oxide and hydroxide materials still remain on the CNTs as indicated by a lighter color on the CNT powder indicating a residue on the CNTs. Then, 0.3-1 wt. % of the treated CNT material was added to a beaker and 99-99.7 wt. % of isopropyl alcohol (IPA) was added to disperse the CNTs.
6) The CNT-IPA solution was sonicated for 20 minutes in an ultrasonic bath for better dispersion. The solution was sprayed (using an air brush) onto a silicon substrate using a mask with a square pattern of area of 2×2 cm².
7) Activation with transparent Scotch Brand Tape was applied to all the CNT cathodes. The details are described in Example 2 above.

In the process described above, the metal oxides were dissolved in a water solution and then coated onto carbon nanotube powders. Other lower work function materials and compounds may also be used to treat CNT to lower the work function for high temperature stability. Lanthanum hexaboride (LaB₆) is a common low work function material used in many high temperature (thermal) field emission applications. ZrC is another possible candidate. There may be other methods not described here that will provide a coating of LaB₆ or the materials described earlier in this disclosure onto carbon nanotubes.

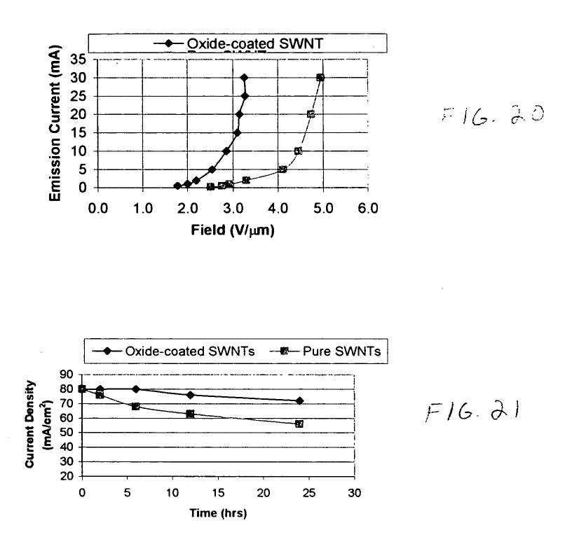

The sample prepared as described above was tested for field emission properties as described earlier. An untreated sample (no metal oxide treatment as described above) was also prepared and tested. The I-V curves of the field emission results of the two samples are plotted in FIG. 20. FIG. 20 illustrates I-V curves from oxide coated Iljin single-walled CNT cathode (4 cm² active area) and an untreated cathode (pure Iljin CNTs and 4 cm² active area) without oxides. The oxide treated sample has a lower threshold. Since the same nanotubes were used for both experiments and they were prepared the same other than the treatment, this indicates that the oxide coating lowered the work function of the treated nanotubes.

The results of field emission life tests of the metal oxide treated and untreated cathodes are shown in FIG. 21. FIG. 21 illustrates a field emission lifetime test of the oxide coated single-walled Iljin CNT cathode prepared as described in Example 3 (0.25 cm² effective area) tested for 24 hours shows only 5% degradation starting from a current density of 80 mA/cm². The pure Iljin cathode (untreated) shows 25% degradation during the 24 hours life test. Although both samples showed a decay over a period of 24 hours, the treated sample showed a lower decay. Again, since the same carbon nanotube material was used for both experiments and that both materials were tested in the same environment and the same field emission intensity was used for both, this indicates that the metal oxide coating contributed to extending the life of the cathode.

Although the present invention and its advantages have been described in detail, it should be understood that various changes, substitutions and alterations can be made herein without departing from the spirit and scope of the invention as defined by the appended claims.

1. A field emission device comprising:
a substrate; and
carbon emitters coated with metal oxides and positioned on the substrate.

2. The field emission device as recited in claim 1, further comprising:
a conductive layer positioned between the substrate and the carbon emitters.

3. The field emission device as recited in claim 1, wherein the carbon emitters further comprise:
single wall carbon nanotubes.

4. The field emission device as recited in claim 1, wherein the carbon emitters further comprise:
multi-wall carbon nanotubes.

5. The field emission device as recited in claim 1, wherein the carbon emitters further comprise:
double wall carbon nanotubes.

6. The field emission device as recited in claim 1, wherein the carbon emitters further comprise:
carbon nanotubes.

7. The field emission device as recited in claim 1, wherein the carbon emitters further comprise:
carbon fibers.

8. The field emission device as recited in claim 1, wherein the carbon emitters further comprise:
carbon flakes.

9. The field emission device as recited in claim 1, wherein the metal oxides further comprise alkaline earth metal oxides.

10. The field emission device as recited in claim 1, wherein the metal oxides are selected from the group comprising BaO, SrO, CaO, and combinations thereof.

11. The field emission device as recited in claim 1, wherein the metal oxides substantially coat an entirety of the carbon emitters.

12. The field emission device as recited in claim 1, wherein the metal oxides partially coat the carbon emitters.

13. The field emission device as recited in claim 1, wherein coating of the carbon emitters by the metal oxides is nonuniform.
